(19) United States
(12) Patent Application Publication
(10) Pub. No.: US 2011/0128267 A1
(43) Pub. Date: Jun. 2, 2011

(54) ELECTRONIC PAPER DISPLAYS AND DRIVING METHOD THEREOF

(76) Inventor: Jeng-Yun HSU, Hsin Chu city (TW)

(21) Appl. No.: 12/791,261

(22) Filed: Jun. 1, 2010

(30) Foreign Application Priority Data
Dec. 2, 2009 (TW) 098141100

(51) Int. Cl. G06F 3/038

(52) U.S. Cl. 345/211

(57) ABSTRACT

The invention discloses an electronic paper display and driving method thereof. The electronic paper display includes a plurality of image units and a control unit. The image units are arranged as a matrix. Before image data received by the electronic paper display being written into the image units, the control unit drives a first image unit of every two adjacent images into a first extreme state and a second image unit of the two adjacent images into a second extreme state during a first preset duration, and drives the first image unit into the second extreme state and the second image unit into the first extreme state during a second preset duration.

### BACKGROUND OF THE INVENTION

(a) Field of the Invention

The invention relates to a display device, particularly to an electronic paper display and a driving method thereof.

(b) Description of the Related Art

The background of the present invention is about electronic paper displays (EPDs), for example, an electrophoretic display. The fundamental principle of an electrophoretic display is that an electrophoretic medium encapsulated in a display device is controllable by electric fields to display images.

Generally, there are many factors to cause an electronic paper display to malfunction, such as the manufacturing processes of the electronic paper display, selection and setting of an electrophoretic material, the display control method and so forth. Among the above, the well known causes are memory effect and remnant DC. The image update of an electronic paper display is related to not only the current driving state but also the history of the display state that is called memory effect. The remnant DC is caused by the electric field driving direction being focused on some direction to result in mismatch between the driving level and the display gray scale. Either of the memory effect and the remnant DC will cause the contrast of the display to be decreased or abnormal. It is known that a symmetrical reset signal added before display update can reset the display state to whole-black and then whole-white (or whole-white and then whole-black) to solve the problem caused by the memory effect as well as the remnant DC because of having the symmetrical reset signal.

However, the symmetrical reset signal causes flicker occurring during frame update to seriously affect the viewing effect. As shown in FIG. 1, during the time coordinates 1˜31, as the frame is updated from “S” to “X”, flicker from white to black and from black to white occurs.

### BRIEF SUMMARY OF THE INVENTION

In light of the above-mentioned problem, one object of the invention is to provide an electronic paper display and a driving method thereof, for reducing flicker during frame update.

One object of the invention is to provide an electronic paper display and a driving method thereof, having a control mechanism on DC (direct current) balance during operation.

One embodiment of the invention provides an electronic paper display, comprising at least one image unit and at least one control unit. The control unit receives an image data and is used to drive the image unit to a first extreme state, a second extreme state, or an image state corresponding to the image data. The control unit uses a control signal to drive the image unit and the control signal comprises at least one reset signal and a data signal. The reset signal selectively sets the image unit during a different preset duration into the first extreme state or the opposite second extreme state. The data signal sets the image unit into the image state after the reset signal sets the image unit.

Another embodiment of the invention provides an electronic paper display, comprising a plurality of image units and a control unit. The image units are arranged to form a matrix. The control unit receives an image data. Before the image data are written into the image units, the control unit drives one first image unit of every two adjacent image units into a first extreme state and drives a second image unit of the two adjacent image units into a second extreme state during a first preset duration. During a second preset duration, the control unit drives the first image unit into the second extreme state and the second image unit into the first extreme state.

Another embodiment of the invention provides an electronic paper display, comprising a plurality of image units and a control unit. The image units are arranged to form a matrix. The control unit receives an image data. Before the image data are written into the image units, the control unit drives at least one first image unit into a first extreme state and selectively drives at least one image unit adjacent to the first image unit to the first extreme state or a second extreme state during a first preset duration. During a second preset duration, the control unit drives the first image unit into the first extreme state or the second extreme state and the at least one image unit adjacent to the first image unit into one extreme state different from its previous extreme state.

Another embodiment of the invention provides an electronic paper display, comprising a plurality of image units and a control unit. The electronic paper display receives a plurality of image data to update frames and the frame update duration is the sum of a first preset duration and a second preset duration. During operation, the control unit drives a first image unit of every two adjacent images into a first extreme state and a second image unit into a second extreme state during a first preset duration of the frame update duration of a first image data; and drives the image units into an image state corresponding to the first image data according to the first image data during a second preset duration of the frame update duration of the first image data. The control unit drives a first image unit of every two adjacent images into a second extreme state and a second image unit into a first extreme state during a first preset duration of the frame update duration of a second image data; and drives the image units into an image state corresponding to the second image data according to the second image data during a second preset duration of the frame update duration of the second image data.

Another embodiment of the invention provides an electronic paper display, comprising an electrophoretic medium, a plurality of image units, two electrodes, and a control unit. The electrophoretic medium comprises a plurality of charged particles in a fluid. Each of the image units is correlated to the particles. The two electrodes are correlated to each image unit and used to receive a control signal. The control unit receives image data and, during a first preset duration, provides the two electrodes with the control signal to drive one first image unit of every two adjacent image units into a first extreme state and drive a second image unit into a second extreme state. During a second preset duration, the control unit provides the two electrodes with the control signal to drive the first image unit into the second extreme state and the second image unit into the first extreme state. In addition, during a third preset duration, according to the image data, the control units drives the image units into an image state corresponding to the image data.

Another embodiment of the invention provides an electronic paper display, comprising an electrophoretic medium, a plurality of image units, two electrodes, and a control unit. The electrophoretic medium comprises a plurality of charged particles in a fluid. The two electrodes are used to receive a control signal. Each of the image units comprises part of the electrophoretic medium, part of the first electrode and part of the second electrode. The control unit receives an image data. Before the image data is written into the image units, during a first preset duration, the control unit provides the two electrodes with the control signal to drive at least one first image unit into a first extreme state and selectively drive at least one image unit adjacent to the first image unit into the first extreme state or a second extreme state. During a second preset duration, the control unit provides the two electrodes with the control signal to drive the first image unit into the first extreme state or the second extreme state and at least one image unit adjacent to the first image unit into one extreme state different from its previous extreme state.

Another embodiment of the invention provides an electronic paper display, receiving a plurality of image data to update frames and having a frame update duration be the sum of a first preset duration and a second preset duration. The electronic paper display comprises an electrophoretic medium, a plurality of image units, two electrodes, and a control unit. The electrophoretic medium comprises a plurality of charged particles in a fluid. The two electrodes are used to receive a control signal. Each of the image units comprises part of the electrophoretic medium, part of the first electrode and part of the second electrode. The control unit provides the control signal to drive at least one first image unit of adjacent images into a first extreme state and drive the at least one other adjacent image into a second extreme state during a first preset duration of the frame update duration of an N^{th} image data. During a second preset duration of the frame update duration of the N^{th} image data, according to the N^{th} image data, the control unit provides the control signal to drive the image units into an image state corresponding to the N^{th} image data. During a first preset duration of the frame update duration of an M^{th} image data, the control unit provides the control signal to drive at least one first image unit of adjacent images into a second extreme state and the at least one other adjacent image unit into a first extreme state. During a second preset duration of the frame update duration of the M^{th} image data, according to the M^{th} image data, the control unit provides the control signal to drive the image units into an image state corresponding to the M^{th} image data. In the above, N and M are positive integers and N is not equal to M.

The driving method of each embodiment of the invention is related to the control method for the above device. Their details will be described in the paragraph of the detailed description of the invention.

The display method of the electronic paper display and the driving method thereof according to the invention selectively drive the image units into the same or different extreme state during at least one different preset duration so that the image unit does not receive the same DC voltage for a long period of time and the electronic paper display shows a grayscale image with a black and white distribution during updating to thereby achieve DC balance and reducing flicker during frame update.

### BRIEF DESCRIPTION OF THE DRAWINGS

FIG. 1 shows a schematic diagram illustrating the frame update of an electronic paper display according to the prior art.

FIG. 2A shows a schematic diagram illustrating an electronic paper display according to one embodiment of the invention.

FIG. 2B shows a schematic diagram illustrating part of modules of the display unit 22 shown in FIG. 2A according to one embodiment of the invention.

FIG. 3A shows a flow chart of the driving method according to one embodiment of the invention.

FIG. 3B shows a waveform diagram of the control signal according to one embodiment of the invention.

FIG. 3C shows a schematic diagram illustrating the frame shown by part of the image units according to one embodiment of the invention.

FIG. 3D shows a schematic diagram illustrating the frame update of an electronic paper display according to one embodiment of the invention.

FIG. 3E shows a schematic diagram illustrating the frame update of an electronic paper display according to another embodiment of the invention.

FIG. 4A shows a schematic diagram illustrating the circuitry layout of an electronic paper display according to another embodiment of the invention.

FIG. 4B shows a waveform diagram of the control signal according to another embodiment of the invention.

FIG. 4C shows a waveform diagram of the control signal according to another embodiment of the invention.

FIG. 5 shows a waveform diagram of the control signal according to another embodiment of the invention.

FIG. 6A shows a waveform diagram of the control signal according to another embodiment of the invention.

FIG. 6B shows a schematic diagram illustrating the frame update of an electronic paper display according to one embodiment of the invention.

FIG. 6C shows a schematic diagram illustrating the frame update of an electronic paper display according to another embodiment of the invention.

FIG. 7 shows a waveform diagram of the control signal according to another embodiment of the invention.

FIG. 8A shows a pattern of the frame according to one embodiment of the invention.

FIG. 8B shows a pattern of the frame according to another embodiment of the invention.

FIG. 8C shows a pattern of the frame according to another embodiment of the invention.

FIG. 8D shows a pattern of the frame according to another embodiment of the invention.

FIG. 8E shows a pattern of the frame according to another embodiment of the invention.

FIG. 8F shows a pattern of the frame according to another embodiment of the invention.

FIG. 8G shows a pattern distribution frequency diagram according to one embodiment of the invention.

### DETAILED DESCRIPTION OF THE INVENTION

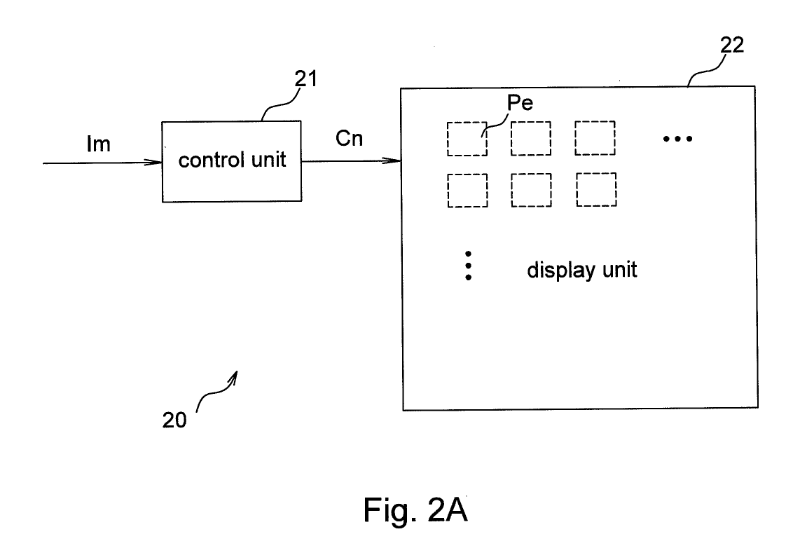

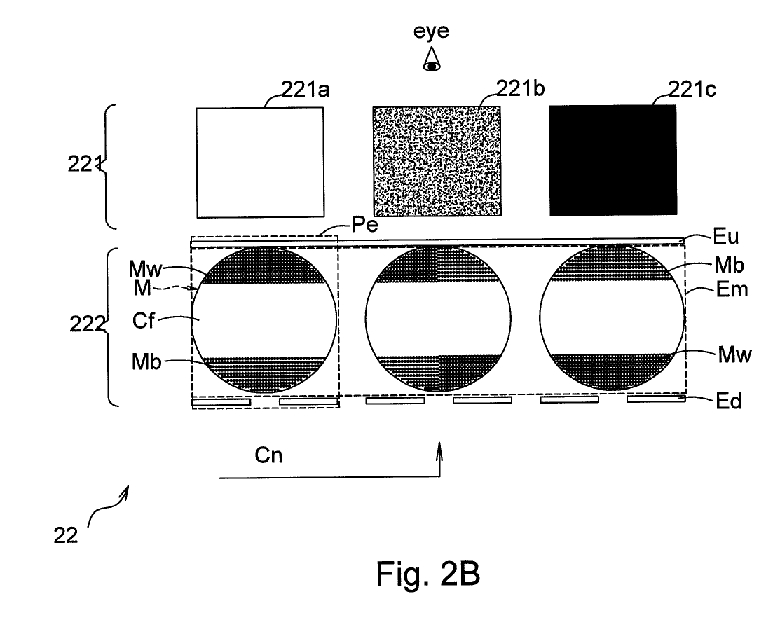

FIG. 2A shows a schematic diagram illustrating an electronic paper display according to one embodiment of the invention. The electronic paper display 20 comprises a control unit 21 and a display unit 22. The control unit 21 receives an image signal Im and generates a control signal Cn (such as voltage difference or pulse, etc.) to drive at least one image unit (or picture element or pixel unit or pixel cell) Pe in the display unit 22. As shown in the figure, the display unit 22 comprises a plurality of image units Pe and these image units Pe can be arranged to form a matrix or some other shapes. The shape of these image units Pe shown in the figure is only as an example. In the present invention, the shape is not limited to the rectangle shown in the figure but can be of various shapes like circle, etc.

FIG. 2B shows a schematic diagram illustrating part of modules of the display unit 22 shown in FIG. 2A according to one embodiment of the invention. The part of modules of the display unit 22 comprises at least one physical medium 222. The physical medium 222 receives at least one control signal Cn and then generates at least one reflectance image 221 according to the control signal Cn.

The physical medium 222 comprises an upper electrode Eu, a lower electrode Ed, and an electrophoretic medium Em. In one embodiment, the upper electrode Eu may be a transparent electrode. The physical medium 222 comprises a plurality of microcapsules M between the upper electrode Eu and the lower electrode Ed. In one embodiment, part of the upper electrode Eu, part of the lower electrode Ed, and part of the electrophoretic medium Em are defined as the above image unit Pe.

In the above, each microcapsule M comprises a plurality of negatively charged black particle (pigment chip) Mb, a plurality of positively charged white particle (pigment chip) Mw, and a clear fluid Cf for electrophoresis. It should be noted that the physical medium 222 of the electronic paper display of the invention can be implemented by various methods. For example, single particle or a plurality of particles are placed in a fluid, the positions of at least two fluids with different colors are used to display images, the directions, positions of some other structure or particle rotation are used to display images, or some other current or future developed methods may also be used to display images. Taking the design using particles and fluids as an example, the physical medium 222 of the invention may be implemented by having the black and white particles in a clear fluid, having white particles in a black fluid, or having black particles in a white fluid, etc. Also, the particles or fluids may be implemented by other opposite colors (for example blue and yellow).

The physical medium 222 of the electronic paper display 20 in each embodiment of the invention has a function of maintaining the display state. The display state means where the position of each particle Mw, Mb in the fluid Cf of the physical medium 222 is maintained. The positions of the particles compose the reflectance image 221. In the electronic paper display 20, the method to control the particles comprises at least two types. One is voltage modulation for providing voltages to the electrodes Eu, Ed within a fixed driving period where the higher voltage results in a whiter (or blacker) grayscale state while the lower voltage results in a less white (or less black) grayscale state. The other one is pulse width modulation for providing a constant positive or negative voltage to the electrodes Eu, Ed where the time length of the driving signal determines a blacker or whiter grayscale state. The longer the driving time is, the whiter (or blacker) the display is.

It should be noted that in the following embodiments the present invention uses, but not limited to, the pulse width modulation to implement the control mechanism and those who are skilled in the art should understand how to use other control methods, such as the voltage modulation, to implement the control mechanism according to the principle described in the embodiments of the invention. The technique of the invention may use any other current or future developed control method that is also incorporated in the scope of the invention.

At first, as the physical medium 222 receives the control signal Cn to generate the electric field between the upper electrode Eu and the lower electrode Ed, the particles Mw, Mb in the microcapsule M are controlled to move to preset positions, shown in FIG. 2B. As the control signal Cn drives the white particles Mw for a preset duration, the white particles Mw move to the upper most position of the microcapsule M to form a white image 221a having the highest reflectance, called a white state. As the control signal Cn (for example different driving signal) drives the black particles Mb for a preset duration, the black particles Mb move to the upper most position of the microcapsule M to form a black image 221c having the lowest reflectance, called a black state. The white state and the black state can be defined as the first extreme state and the second extreme state, respectively. The control signal Cn with the same or different signal type or through a different duration may be used to drive the particles to move to other positions to form various gray images, called a gray state, or intermediate gray state. It should be noted that the invention is not limited to such condition. In another embodiment, the black state may be defined as the first extreme state while the white state may be defined as the second extreme state.

It should be noted that the particles in the microcapsule M maintain unmoved by means of physical force (for example attractive force) without providing the electric field while the electronic paper display 20 according to the embodiment of the invention does not update its frame. By this mechanism, the electronic paper display 20 according to the invention can appropriately control the image units Pe (such as changing the display color of each image unit Pe) to achieve the effect of displaying the images or texts corresponding to the image data received by the electronic paper display 20.

It should be noted that the electronic paper display 20 according to the invention may be designed to provide no control signal after the particles Mw, Mb are driven to move to the preset positions so that the particles Mw, Mb are maintained unmoved by means of physical force. In another embodiment, when the particles Mw, Mb move to the preset positions, a control signal may be provided to adjust the positions of the particles Mw, Mb. Or, in some circumstances, the control signal may still continue to be provided.

The following will describe a driving method of the electronic paper display 20 according to one embodiment of the invention.

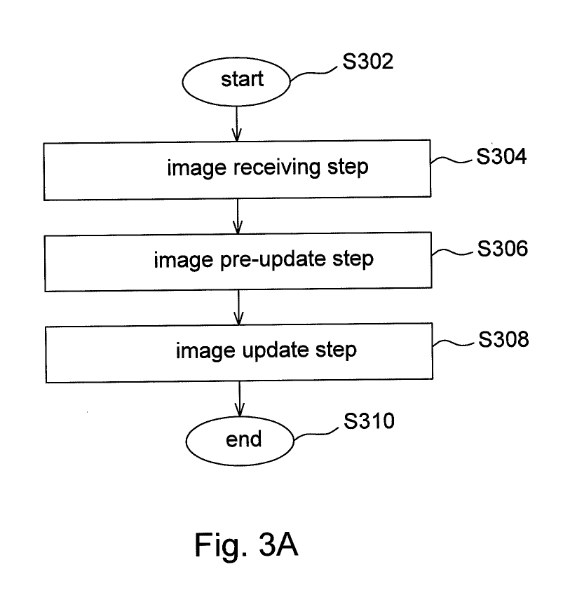

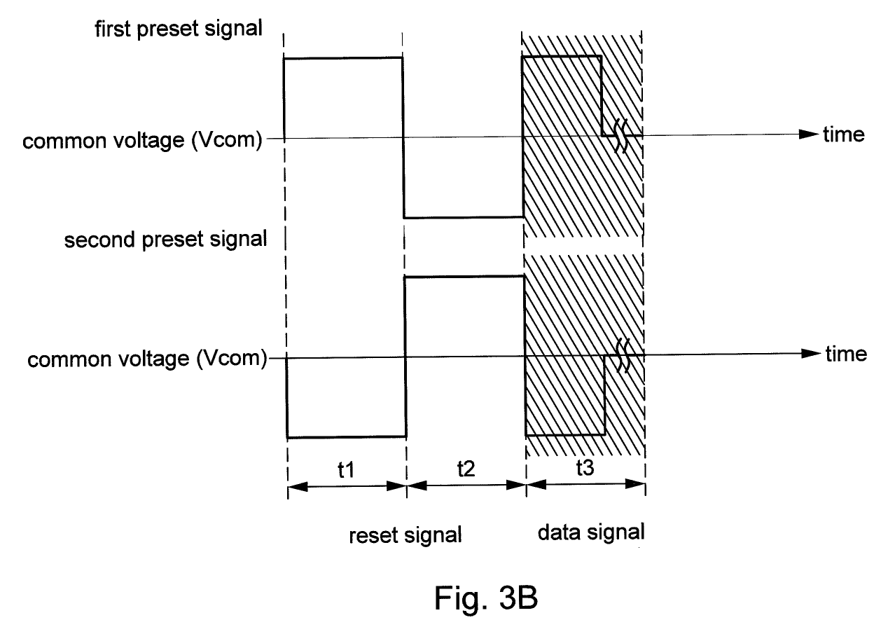

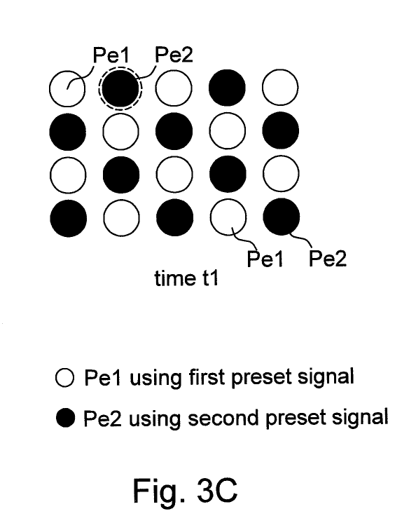

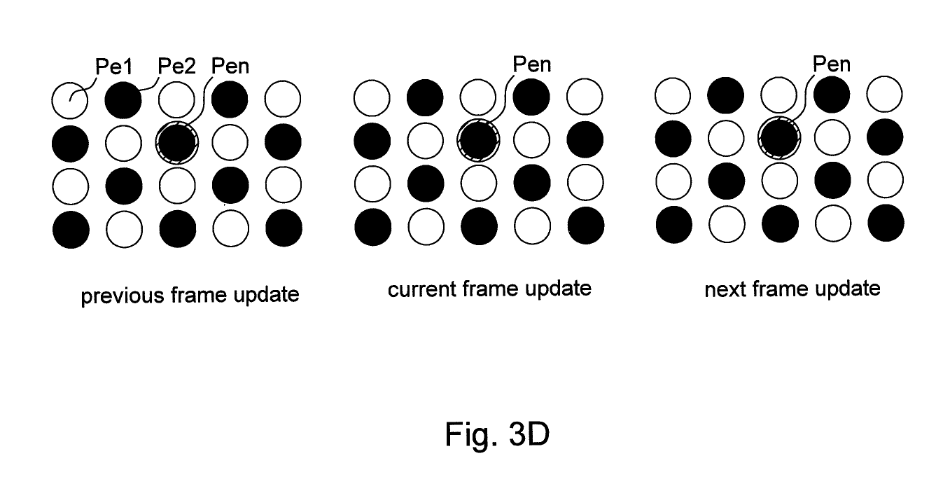

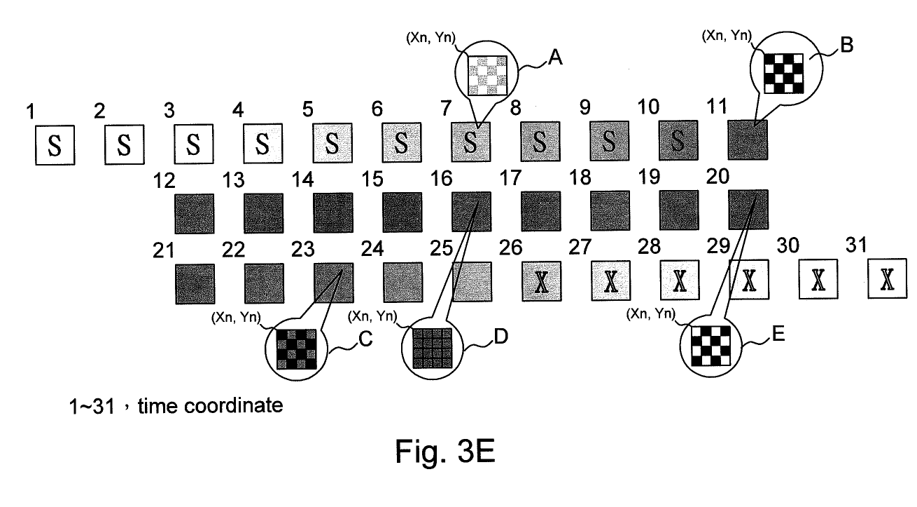

Please refer to FIGS. 3A-3E. FIG. 3A shows a flow chart of the driving method according to one embodiment of the invention. The method comprises the following steps:

Step S302: start;

Step S304: image receiving step where the electronic paper display 20 receives an image data Im;

Step S306: image pre-update step, referring to FIGS. 3B and 3C, where FIG. 3B shows a first preset signal and a second preset signal of the control signal Cn (the two preset signals both comprise a reset signal and a data signal) and FIG. 3C shows the frame shown by part of the image units Pe of the display unit 22;

Step S308: image update step; and

Step S310: end.

In the step S306, before the image data Im received by the electronic paper display 20 is written into the image units Pe of the display unit 22, shown in FIGS. 3B and 3C, the control unit 21 uses the first preset signal to drive the first image unit Pe1 of every two adjacent image units Pe; and uses the second preset signal to drive the second image unit Pe2 of every two adjacent image units Pe. Therefore, during a first preset duration t1 (referring to FIGS. 3B and 3C), the first image unit Pe1 of every two adjacent image units Pe is driven to a first extreme state to have Pe1 appear white while the second image unit Pe2 of every two adjacent image units Pe is driven to a second extreme state to have Pe2 appear black. During a second preset duration t2, the first image unit Pe1 of every two adjacent image units Pe is driven to the second extreme state to have Pe1 appear black while the second image unit Pe2 of every two adjacent image units Pe is driven to the first extreme state to have Pe2 appear white.

In the step S308: image update step, during a third preset duration t3, according to the image data Im, the control unit 21 generates the corresponding driving signal Cn to drive the image units Pe into the image state. The particles Mw, Mb of the image units Pe are driven to the positions corresponding to the image data Im to display an image.

It should be noted that the sum of the first preset duration, the second preset duration, and the third preset duration is one frame update duration of the electronic paper display 20, as shown in FIG. 3D. The same image unit Pe can be driven to the first extreme state and the second extreme state after the time t1 and t2 (reset periods). Thus, any image unit Pe will not be continuously at the same state, that is, will not receive the same DC voltage for a long period of time so that each image unit Pe can be under DC balance. Till the time t3, the data can be normally written into the image units to display an image.

Besides, since every two adjacent image units Pe at the time t1 and t2 are driven by voltages with different polarity to visually appear to be one black and one white. Thus, the frame shows uniform grayscale during at least one reset period (such as the time t1 or t2). Therefore, as every two frames are under update shown in FIG. 3D, a black and white grid grayscale pattern is shown during the reset period while switching frames. Thereby, the flicker phenomenon can be removed while updating two frames in the electronic paper display 20.

It should be noted that in this embodiment, as for the left, middle, and right sets of the image units Pe from FIG. 3D, the same image unit Pe (for example image unit Pen) uses the same preset signal while the frame is updated. Thus, each image unit Pe passes through the black and white extreme states after the frame updates.

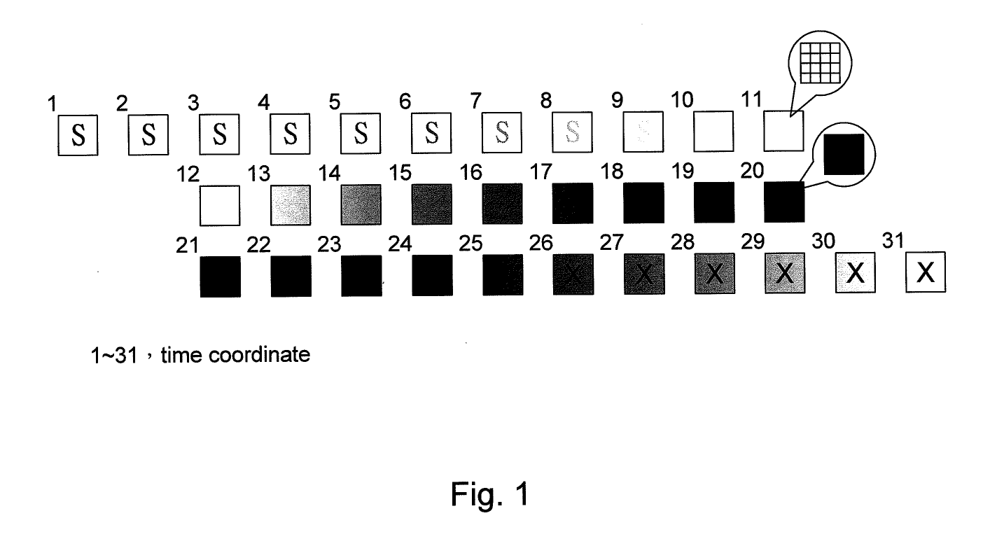

For example, FIG. 3E shows a schematic diagram during frame switching (updating) of the electronic paper display 20. The electronic paper display 20 can reduce flicker occurring (Such that the flicker of the frame shown in FIG. 1 executed by the prior art) during frame switching from “S” to “X”.

According to the electronic paper display 20 and the driving method of one embodiment of the invention, as the frame from the initial image “S” at the time coordinate 1 updates to the target image “X” at the time coordinate 31, there are the intermediate images from the time 2 to 30, that is, the current reflectance is updated towards a desired reflectance. In the continuous updating frames shown in FIG. 3E, as the frame is updated from “S” to “X”, the adjacent image units Pe will be driven by different signal waveforms from the time 2 to 30 so that the adjacent image units Pe1 and Pe2 appear different colors. For example, the image unit Pe1 appears white and the image unit Pe2 appears black, as shown in FIG. 3D.

By means of the above method, as shown in FIG. 3E, the continuous intermediate images appear substantially to be a grayscale state from the time 2 to 30. If the frame is enlarged, shown in the enlarged diagrams A˜E of FIG. 3E, it shows a black-and-white-grid pattern or near black-and-white-grid pattern. The enlarged areas in the diagrams A˜E are the same where the coordinate of the starting point is (Xn, Yn). Such high-frequency pattern appears to be continuous frames with grayscale states visually under the normal frame size viewed by human eyes. Thus, during frame update, intermediate continuous gray levels are added in between to avoid converting directly from black into white or directly from white into black so that flicker is reduced.

In conclusion, while the electronic paper display 20 processes frame updating, the continuous grayscale frames will be generated (for example from time 12 to 20) so that the continuous gray level change makes human eyes feel less color change to achieve the purpose of reducing flicker occurring during frame switching (updating). Furthermore, the same image unit Pe is driven to different extreme states at least once during frame update so as to achieve the DC balance of the image unit Pe. At the same time, the problems of flicker and DC unbalance in the prior art are also solved.

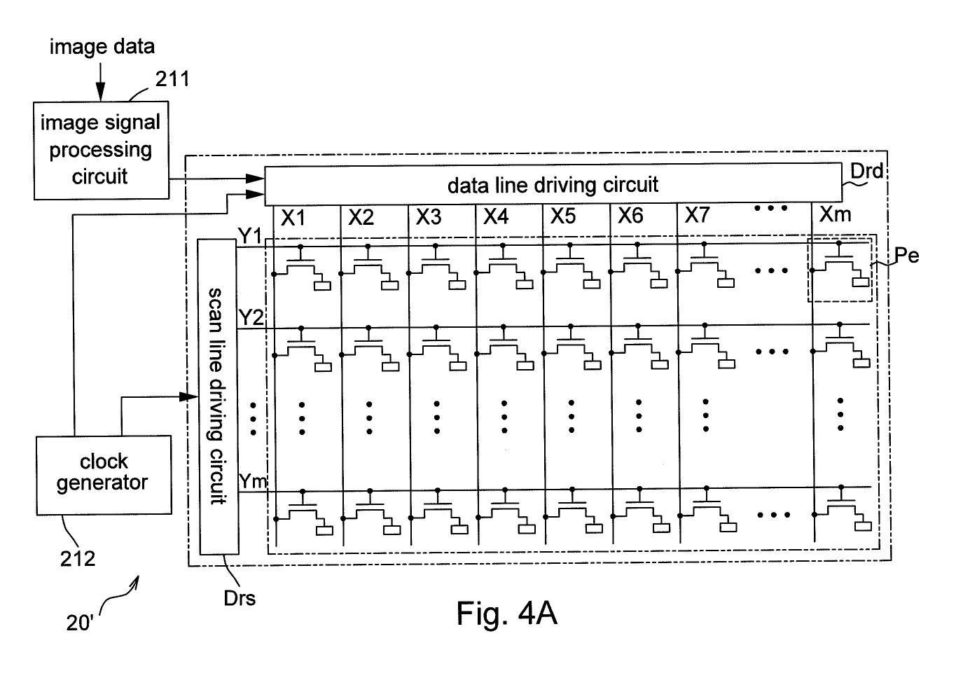

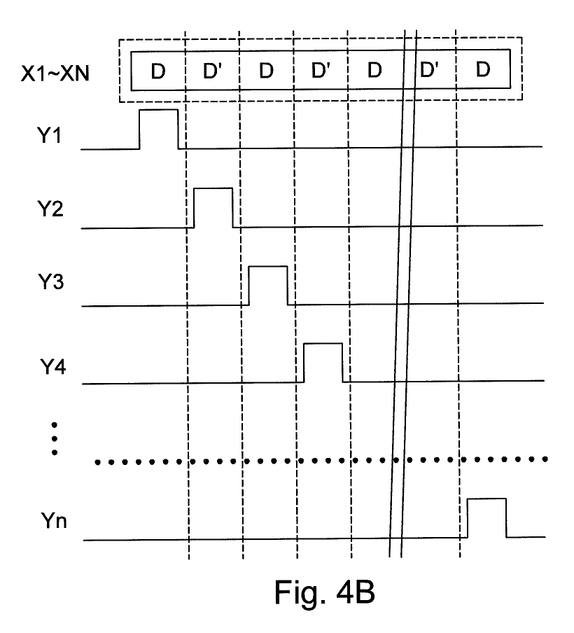

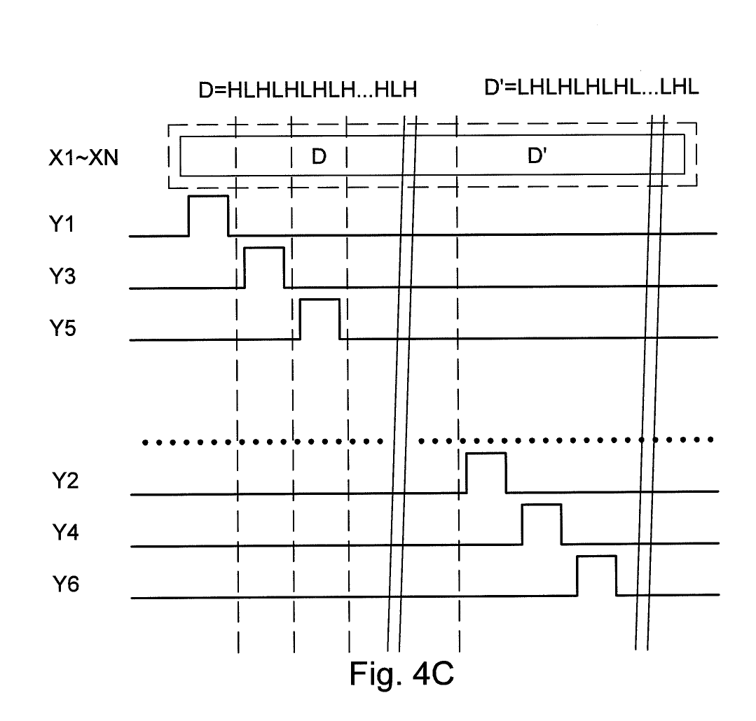

FIG. 4A shows a schematic diagram illustrating the circuitry layout of the electronic paper display 20′ according to another embodiment of the invention. The control unit 21 of the electronic paper display 20′ comprises an image signal processing circuit 211, a clock generator 212, a data line driving circuit Drd, and a scan line driving circuit Drs. The display unit 22 comprises a plurality of image units Pe arranged to form a matrix. It should be noted that this embodiment is an active matrix driven display device. Those who are skilled in the art should understand the configuration and characteristic of the device and thus the details of each circuitry will not be described hereinafter.

During operation, the electronic paper display 20′ receives the waveform shown in FIG. 4B to drive the image units Pe. By means of the method, the high-frequency pattern with a black and white distribution shown in FIG. 3D can be acquired. Till now, according to the above description, those who are skilled in the art should understand that the circuit follows the operation logic of the waveform shown in FIG. 3B and thus the flicker problem while the electronic paper display updates frames can be reduced and the DC balance can also be achieved.

Besides, in order to save the power consumption of the data line driving circuit Drd, the electronic paper display 20′ can use the driving waveform shown in FIG. 4C. Referring to FIG. 4C, the image units Pe are respectively corresponding to the scan lines. The scan lines are separated into two groups. One is a first preset group including the odd number (X) scan lines (X is a positive integer and less than infinity) and the other is a second preset group including the even number (Z) scan lines (Z is a positive integer and less than infinity). During a different preset duration, the image unit Pe of the first preset group is continuously driven and the image unit Pe of the second preset group is continuously driven, separately. Thus, the data line driving circuit Drd only needs to generate the proper control signals to the scan lines of the two groups and the control signal are used to control the scan lines of the two groups so that the circuit does not need to control every image unit Pe. For example, assuming the first preset group is all the odd number scan lines and the second preset group is all the even number scan lines. Thus, the odd number scan lines Y1, Y3, Y5 . . . drive the image unit Pe according to the driving signal D=HLHLHLH . . . while the even number scan lines Y2, Y4, Y6 . . . drive the image unit Pe according to the driving signal D′=LHLHLHL . . . . Thereby, the number of times in changing the driving signal can be reduced to achieve power saving and can still obtain the high-frequency pattern with a black and white distribution, shown in FIG. 3D. Thus, the problems of flicker and DC balance can be solved.

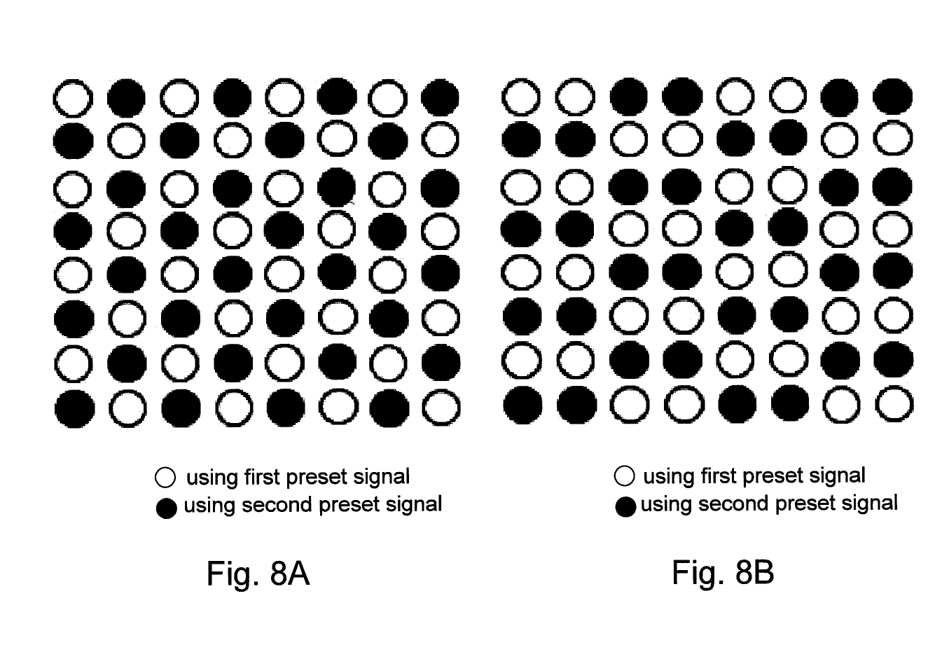

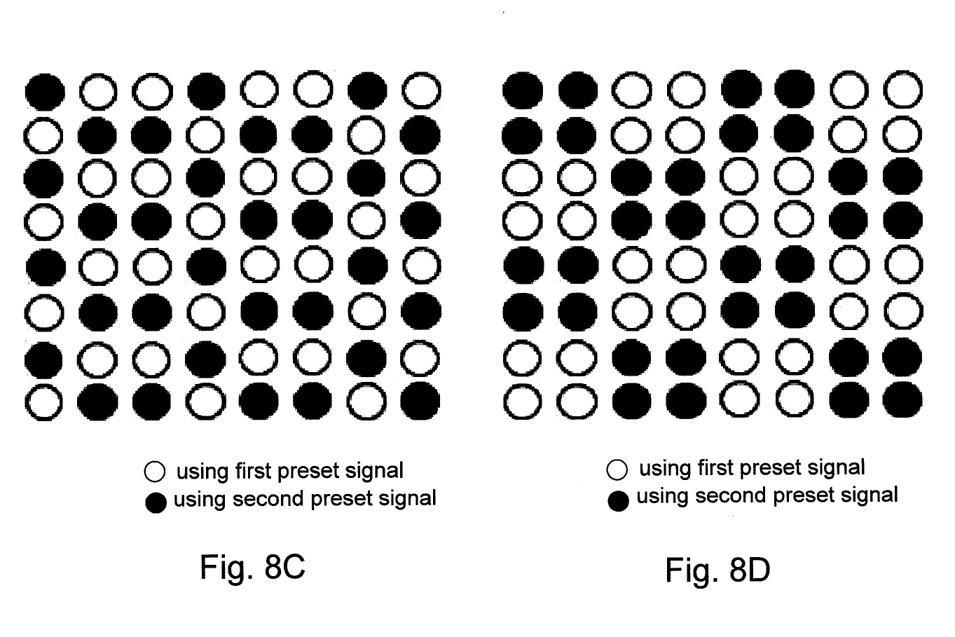

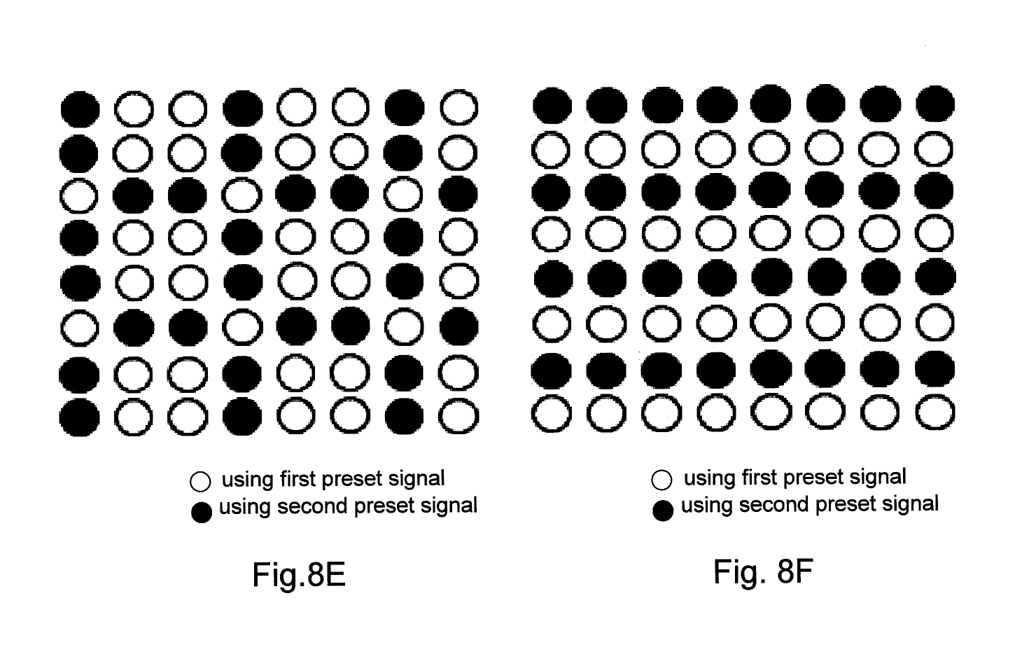

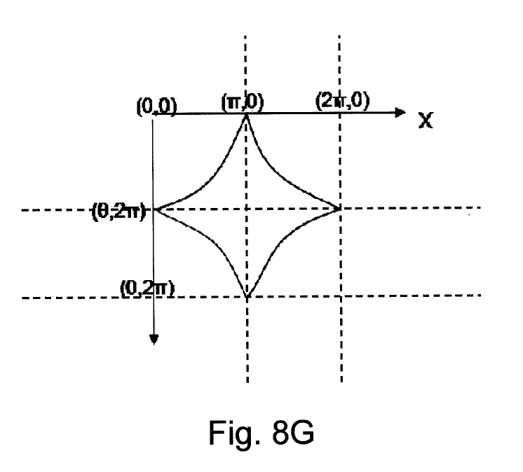

It should be noted that the driving method of the electronic paper display of the invention is not limited to the way of dividing into two groups but the way of dividing into a plurality of groups (more than two). The number of scan lines in these groups may be the same or different depending on the designer. The key is to decrease the number of times in changing the driving signal D. The method of dividing into a plurality of groups can be implemented with the patterns shown in FIGS. 8A-8F. The invention is not limited to the patterns shown in the figures. The design pattern depends on the requirements. Besides, the driving circuits of the electronic paper display of the invention are not limited to the above description. Any passive display device or any current or future developed display device is applicable. Those who are skilled in the art may design according to the spirit of the present invention without deviating from the scope of the claimed invention.

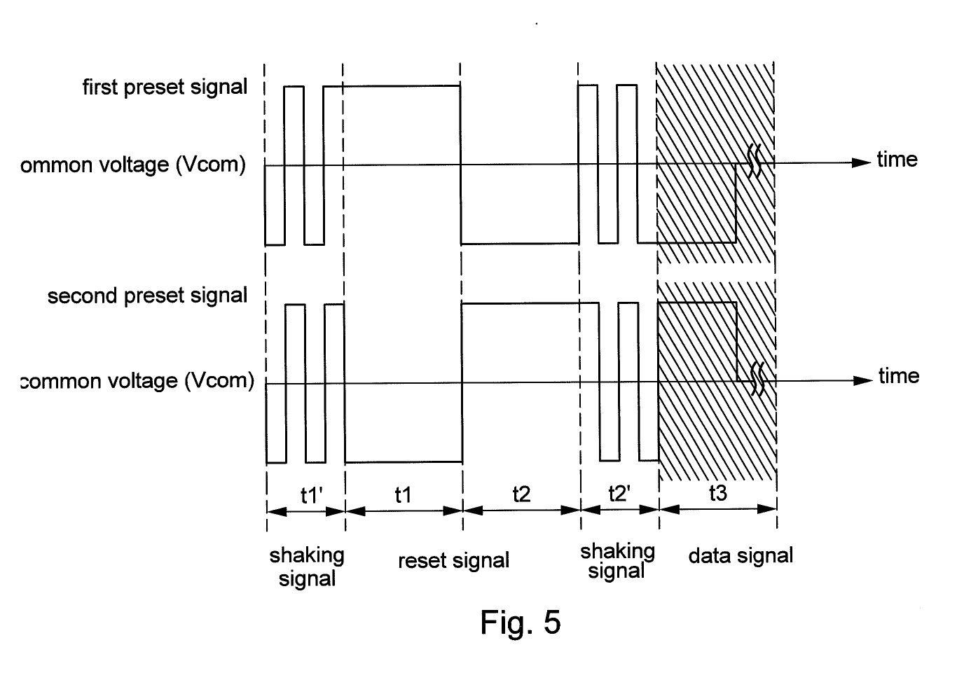

Furthermore, the driving signal of the electronic paper display 20 may further comprise a shaking signal, as shown by the waveform in FIG. 5 from the time t1′ to t2′. The shaking signal can increase the mobility of the white and black particles Mw, Mb of the physical medium 222 shown in FIG. 2B. As shown in the figure, the shaking signal has an effect of increasing the driving speed for the reset signal and the data signal. In one embodiment, the shaking signal comprises only one pulse or two pulses shown in the figure. The shaking signal may comprise more than two pulses. In another embodiment, the shaking signal is selectively applied before the reset signal and/or the data signal or during a preset duration set by a designer, such as some duration while writing the data signal.

It should be noted that the electronic paper display 20 and the driving method thereof according to the embodiment of the invention can always drive the image unit Pe to one extreme state during the update duration of a preset number of the frame and always drive the image unit Pe to the other opposite extreme state during the update duration of another preset number of the frame.

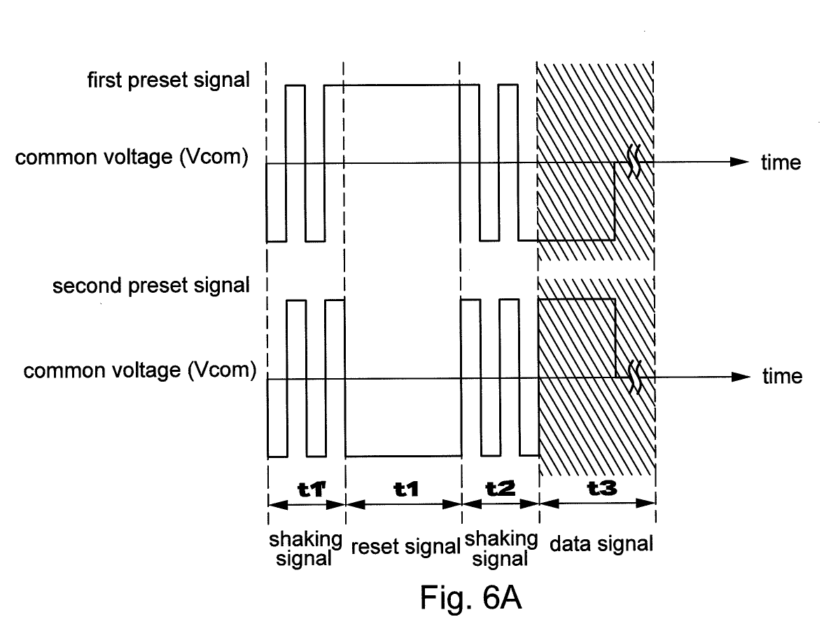

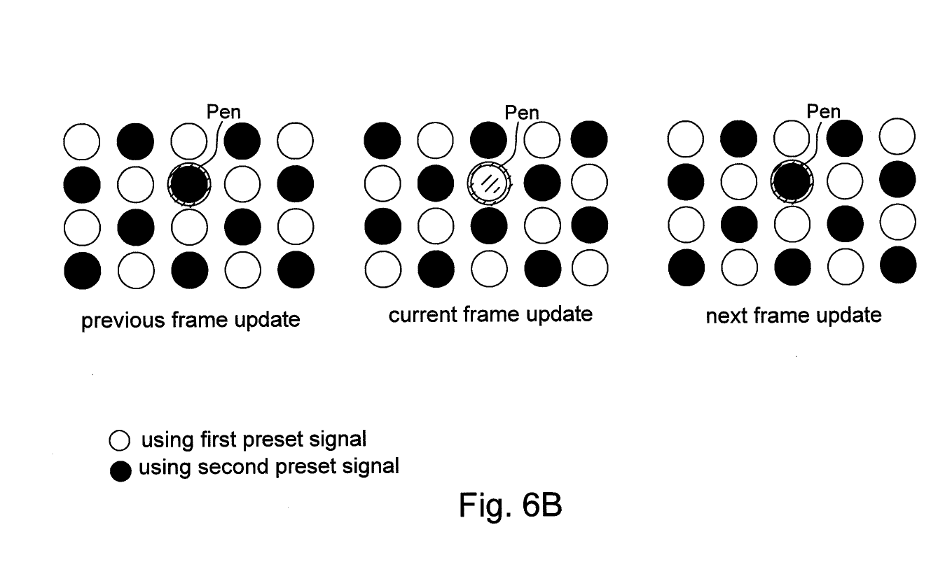

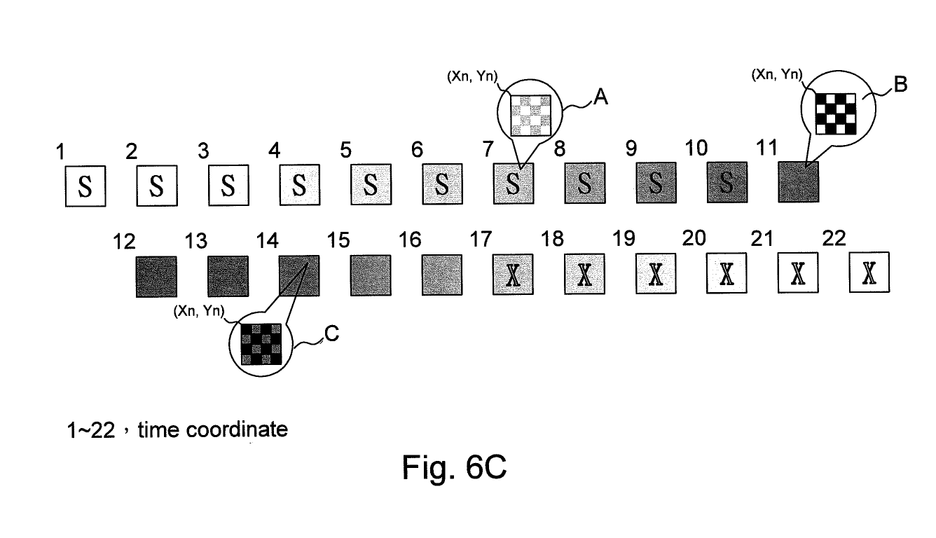

Please refer to FIGS. 6A and 6B. FIG. 6A shows a waveform diagram of the control signal Cn of the electronic paper display according to another embodiment of the invention. The control signal Cn comprises a first preset signal and a second preset signal. FIG. 6B shows a schematic diagram illustrating the frame shown by part of the image units Pe of the display unit 22. In the figure, the white image unit uses the first preset signal and the black image unit uses the second preset signal. It should be noted that the control signal Cn only comprises one reset signal (time t1). Thus, the design is that the image unit Pe is driven to one extreme state after the update duration of a frame and then the image unit Pe is driven to the other opposite extreme state during the update duration of next frame. As shown in FIG. 6B, taking the image unit Pen as an example, the image unit Pen is at the black state (the second extreme state) according to the second preset signal during the update duration of the previous frame. The image unit Pen is at the white state (the first extreme state) according to the first preset signal during the update duration of the current frame. By this method, in the same frame, the adjacent pixels use different preset signals to generate a high-frequency grayscale pattern. In a different frame, the same pixel is driven to the opposite extreme state. Thus, reducing flicker occurring and DC balance can be achieved. In addition, one reset time t2 is reduced to increase the frame update speed of the electronic paper display. As shown in FIG. 6C, the control signal Cn shown in FIG. 6A is used and only the time t1˜22 can complete the frame update. The above description is only an example. The invention is not limited to the above example.

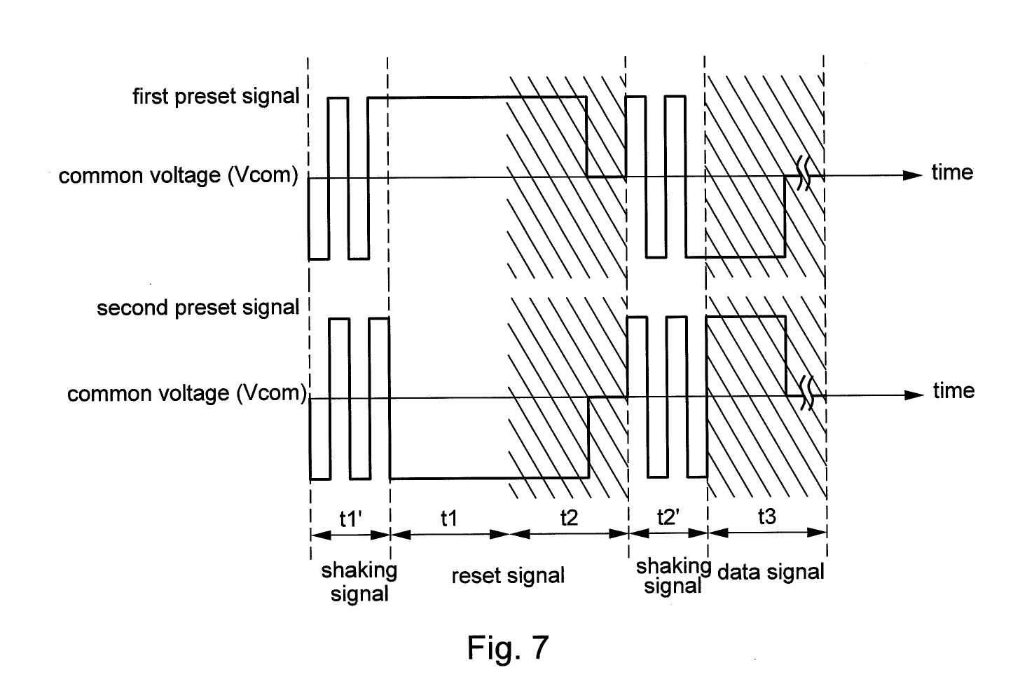

Furthermore, the electronic paper display of the invention can use the control signal Cn shown in FIG. 7. In the figure, the control signal Cn comprises shaking signals (time t1′ and t2′), reset signals (time t1 and t2), and a data signal (time t3). The time t2 of the reset signal in this embodiment is not fixed and is designed to be the corresponding inverse of the data signal. By means of this method, the electronic paper display according to the embodiment of the invention can reach 100% of DC balance and can obtain the black-and-white-distributed high-frequency pattern to reduce flicker occurring during frame update.

The control unit 21 of the electronic paper display 20 according to another embodiment of the invention, before the image data is written into the image units Pe, drives at least one first image unit Pe1 into a first extreme state and selectively drives at least one image unit adjacent to the first image unit into the first extreme state or a second extreme state during a first preset duration. During a second preset duration, the control unit 21 drives the first image unit Pe1 into the second extreme state and the at least one image unit Pe into one extreme state opposite to the previous extreme state. During a third preset duration, the control unit 21 drives the image units into the image state corresponding to the written data to display an image. By means of this method, during the frame update duration of the electronic paper display 20, the image units Pe for showing the frame are driven to show the patterns such as shown in FIGS. 8A˜8F. These patterns show grayscale images if enlarged and thus can reduce flicker during frame update. The patterns shown in FIGS. 8A˜8F are only examples and the invention is not limited to these examples. Besides, it should be noted that the appearance frequency of the black and white distribution of these patterns can be as shown in FIG. 8G. As the density of the black and white distribution is higher, the frequency is higher. As the frequency is closer to (π,π), the display effect of the grayscale image is better. That is, the adjacent black and white distribution shown in FIG. 3C is closest to (π,π).

It should be noted that the electronic paper display and the driving method according to each embodiment of the invention can be applied to any current or future developed display device, such as a bi-stable display comprising an electrophoretic display. Any current or future developed driving scheme, such as pulse-width modulation, voltage modulation, or the combination of the above two methods, can be applied to the configuration of each embodiment of the invention. Moreover, the electrodes used in each embodiment of the invention are not limited to any specific structure. Any current or future developed electrode can be used, such as having top-bottom structure, honeycomb structure, or comb shaped structure. In the above embodiment, the control method can be designed that the control signal does not use a shaking signal.

The display method of the electronic paper display and the driving method thereof according to the invention selectively drive the image units into the same or different extreme state during at least one different preset duration so that the image unit does not receive the same DC voltage for a long period of time and the electronic paper display shows a grayscale image with a black and white distribution during updating to thereby achieve DC balance and reducing flicker during image update.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. An electronic paper display, comprising:
at least one image unit; and
at least one control unit, for receiving an image data and using a control signal to drive the image unit among a first extreme state, a second extreme state, and an image state corresponding to the image data wherein the control signal comprises:
at least one reset signal, for selectively setting the image unit during a different preset duration into the first extreme state or the second extreme state; and
a data signal, for setting the image unit into the image state after the reset signal sets the image unit.

2. The display according to claim 1, wherein, as the display comprises a plurality of image units, the frame shown by the image units during at least one reset period forms a high-frequency pattern distributed with opposite colors adjacent to each other where the reset period is substantially the same as the preset duration.

3. The display according to claim 1, wherein the image unit comprises at least one particle and at least one fluid and the particle moves to a preset position in the fluid according to the control signal.

4. The display according to claim 3, wherein the particle at the preset position composes a reflectance image of the first extreme state, the second extreme state, or the image state.

5. The display according to claim 3, wherein, as the image unit comprises a plurality of particles, all the particles are set to posses the same charges, or some of the particles are set to posses positive charges and some are set to posses negative charges.

6. The display according to claim 3, wherein the color of the particles is the opposite color of the fluid, or the fluid is transparent and some of the particles are white and some are black.

7. The display according to claim 1, wherein the first extreme state is a state having a first color, the second extreme state is a state having a second color where the first color and the second color are opposite colors to each other, and at least one intermediate state exists between the first extreme state and the second extreme state.

8. An electronic paper display, comprising:
a plurality of image units wherein the image units are arranged to form a matrix; and
a control unit, for receiving an image data and then driving at least one first image unit into a first extreme state and selectively driving at least one image unit adjacent to the first image unit into the first extreme state or a second extreme state before the image data is written into the image units during a first preset duration; and driving the first image unit into the first extreme state or the second extreme state and at least one image unit adjacent to the first image unit into one extreme state different from the previous extreme state during a second preset duration.

9. The display according to claim 8, wherein the control unit drives the image units into an image state corresponding to the image data for displaying an image during a third preset duration.

10. The display according to claim 8, wherein the sum of the first preset duration and the second preset duration is a reset period within one frame update duration of the electronic paper display, and the frame shown by the image units comprises a black and white distribution or a high-frequency pattern distributed with opposite colors during the reset period.

11. The display according to claim 8, wherein the first extreme state and the second extreme state are the states having opposite colors to each other.

12. The display according to claim 8, wherein the image unit comprises at least one particle and at least one fluid; the particle moves to at least one preset position in the fluid according to the control signal; and the particles at these positions separately compose the reflectance image of the first extreme state, the second extreme state, or an image state.

13. An electronic paper display, receiving a plurality of image data to update frames and having a frame update duration be the sum of a first preset duration and a second preset duration, the electronic paper display comprising:
a plurality of image units; and
a control unit, for driving a first image unit of every two adjacent images into a first extreme state and a second image unit of the two adjacent images into a second extreme state during a first preset duration of the frame update duration of a first image data; and driving the image units into an image state corresponding to the first image data according to the first image data during a second preset duration of the frame update duration of the first image data; for driving a first image unit of every two adjacent images into a second extreme state and a second image unit of the two adjacent images into a first extreme state during a first preset duration of the frame update duration of a second image data; and driving the image units into an image state corresponding to the second image data according to the second image data during a second preset duration of the frame update duration of the second image data.

14. The display according to claim 13, wherein the frame shown by the image units comprises a black and white distribution or a high-frequency pattern distributed with opposite colors during the frame update duration.

15. The display according to claim 13, wherein the image unit comprises at least one particle and at least one fluid; the particle moves to at least one preset position in the fluid according to the control signal; and the particles at these positions separately compose the reflectance image of the first extreme state, the second extreme state, or the image state.

16. An electronic paper display, receiving a plurality of image data to update frames and having a frame update duration be the sum of a first preset duration and a second preset duration, the electronic paper display comprising:
an electrophoretic medium, comprising a plurality of charged particles in a fluid;
a first electrode and a second electrode, for receiving a control signal;
a plurality of image units, each of which comprises part of the electrophoretic medium, part of the first electrode and part of the second electrode; and
a control unit, for providing the control signal to drive at least one first image unit of two adjacent images into a first extreme state and drive the other adjacent image into a second extreme state during a first preset duration of the frame update duration of an N^{th} image data; and providing the control signal to drive the image units into an image state corresponding to the N^{th} image data according to the N^{th} image data during a second preset duration of the frame update duration of the N^{th} image data; and for providing the control signal to drive at least one first image unit of two adjacent images into a second extreme state and the other adjacent image unit into a first extreme state during a first preset duration of the frame update duration of an M^{th} image data; and providing the control signal to drive the image units into an image state corresponding to the M^{th} image data according to the M^{th} image data during a second preset duration of the frame update duration of the M^{th} image data;
wherein N and M are positive integers and N is not equal to M.

17. The display according to claim 16, wherein the frame shown by the image units comprises a black and white distribution or a high-frequency pattern distributed with opposite colors during the frame update duration.

18. The display according to claim 16, wherein the first extreme state and the second extreme state are the states having a white color or a black color, and the color of the first extreme state and the color of the second extreme state are opposite color to each other.

19. The display according to claim 16, wherein the image unit comprises at least one particle and at least one fluid; the particle moves to at least one preset position in the fluid according to the control of the control signal; and the particles at these positions separately compose the reflectance image of the first extreme state, the second extreme state, or the image state.

20. A display driving method, comprising:
providing a plurality of image units;
receiving an image data;
driving at least one first image unit into a first extreme state and selectively driving at least one image unit adjacent to the first image unit into the first extreme state or a second extreme state during a first preset duration before the image data is written into the image units; and
driving the first image unit into the first extreme state or the second extreme state and driving at least one image unit adjacent to the image unit into one extreme state different from the previous extreme state during a second preset duration.

21. The method according to claim 20, further comprising:
driving the image units into an image state corresponding to the image data based on the image data for displaying an image during a third preset duration wherein the sum of a first preset duration, a second preset duration, and a third preset duration is the frame update duration.

22. The method according to claim 20, wherein the frame shown by the image units comprises a black and white distribution or a high-frequency pattern distributed with opposite colors during the frame update duration.

23. A display driving method, comprising:
receiving a plurality of image data to update frames and having a frame update duration be the sum of a first preset duration, a second preset duration, and a third preset duration;
providing a plurality of image units;
driving a first image unit of every two adjacent images into a first extreme state and a second image unit of the two adjacent images into a second extreme state during a first preset duration of the frame update duration of a first image data; and driving the image units into an image state corresponding to the first image data according to the first image data during a second preset duration of the frame update duration of the first image data; and
driving a first image unit of every two adjacent images into a second extreme state and a second image unit of the two adjacent images into a first extreme state during a first preset duration of the frame update duration of a second image data; and driving the image units into an image state corresponding to the second image data according to the second image data during a second preset duration of the frame update duration of the second image data.

24. The method according to claim 23, wherein the frame shown by the image units comprises a black and white distribution or a high-frequency pattern distributed with opposite colors during the frame update duration.
